(19) United States
(12) Patent Application Publication
(10) Pub. No.: US 2013/0071761 A1
(43) Pub. Date: Mar. 21, 2013

(54) CATALYTIC CATHODE FOR LITHIUM-AIR BATTERIES

(71) Applicants: Khalil Amine, Oakbrook, IL (US); Yang Qin, Naperville, IL (US); Zhengcheng Zhang, Naperville, IL (US)

(72) Inventors: Khalil Amine, Oakbrook, IL (US); Yang Qin, Naperville, IL (US); Zhengcheng Zhang, Naperville, IL (US)

(21) Appl. No.: 13/234,680

(22) Filed: Sep. 16, 2011

(51) Int. Cl. H01M 4/86; H01M 8/22; B01J 21/18

(52) U.S. Cl. 429/405; 502/182; 502/172; 502/150; 502/167; 502/185; 502/184; 502/183

(57) ABSTRACT

A process includes contacting a carbon support material with an oxidizing agent followed by the acid treatment to form a functionalized carbon support material including surface hydroxyl functionality; contacting the functionalized carbon support material with a solution of a catalyst precursor; and adjusting the pH of the solution to produce a carbon supported catalyst material including a metal oxide catalyst.

### GOVERNMENT RIGHTS

The United States Government has rights in this invention pursuant to Contract No. DE-AC02-06CH11357 between the United States Government and UChicago Argonne, LLC, representing Argonne National Laboratory.

### FIELD

Generally, the present technology relates to cathode materials for lithium-air batteries.

### BACKGROUND

Metal-air batteries combine a metal anode, similar to that used in conventional primary batteries, and an air (oxygen) gas-diffusion electrode (cathode). The metal anode in a metal-air battery is typically based on Zn, Al, Mg, Ca, or Li, and during operation of the battery, the anode is electrochemically oxidized, while the air that enters the battery is reduced. A classic example of a metal air battery is the ubiquitous zinc-air “hearing aid” cell.

Of the various metal-air battery chemical couples, the lithium-air battery is one of the most energy dense and environmentally friendly electrochemical power sources. The cell discharge reaction, for example

2Li+O₂→Li₂O₂; G°=−145 Kcal (Eq. 1)

4Li+O₂→2Li₂O; G°=−268 Kcal (Eq. 2)

has an open circuit voltage of 3.1 and 2.91V, respectively, and a theoretical specific energy of 5,200 and 3,600 Wh/kg, respectively. In practice, oxygen is not stored in the battery, and the theoretical specific energy excluding oxygen is 11,140 Wh/kg. The Li-air battery is composed of a Li metal anode and an air cathode where the cathode active material, oxygen, is accessed from the environmental to react with Li ions on a porous carbon support.

In the discharge of the Li-air battery, the oxygen is reduced and the products are stored in the pores of the carbon electrode. As a result, the cell capacity is expressed as ampere-hour per kilogram of the carbon in the cathode. The specific characteristics, such as Ah/kg and Ah/1 of the metal-air batteries are significantly higher than that of the classical electrochemical systems with the same metal anode. The theoretical data shows that Li and Ca possess very high energy density of 13,172 and 4,560 Ah/kg, respectively. However, Li and Ca are not suitable to be used as anodes in the air cells because of their instability in aqueous electrolytes, or in high humidity situations. The Li ion conducting gel polymer electrolytes used to construct polymer Li-air cells include those based on poly(acrylonitrile) (PAN) and poly(vinylidene fluoride) (PVdF). The electrolyte can also be organic liquid, dry organic polymer or inorganic solid electrolytes.

The cathode in all types of metal-air cells and metal-air batteries is an air-diffusion electrode. The air-gas-diffusion electrode is a porous thin, light plate, which serves as a wall of the metal-air cell and separates the electrolyte in the cell from the surrounding air. The air electrode in a lithium-air cell may contain an active catalyst for the electrochemical reduction of oxygen and the oxidation of the Li₂O₂/Li₂O in contact with the electrolyte. Commonly used catalysts include transition metal oxides, such as MnO₂, Fe₃O₄, Fe₂O₃, and Co₃O₄. The particle size and distribution of the catalyst, determine, at least in part, the performance of a Li-air cell. Ideally, the smaller the catalyst particles, the more uniform the distribution, and the better the performance. Typically, an air cathode is prepared by mechanically mixing the catalyst with a carbon support material. However, uniform dispersion of the catalyst is difficult to achieve by mechanical mixing, and aggregation of the catalyst in the carbon supporting material is hard to avoid. Furthermore, most metal oxides have poor electric conductivity, and aggregation of the less conductive catalysts poses a barrier for the catalyst to promote the reduction of the lithium oxides.

### SUMMARY

In one aspect, a nano-sized metal oxide catalyst and a carbon supporting material are simultaneously formed to provide a carbon supporting material with a uniformly distributed metal oxide catalyst.

In another aspect, a process is provided for preparing a catalyst including depositing a metal hydroxide or metal carbonate from a metal solution onto the surface of a functionalized carbon support material to form a first material; and sintering the first material to form the catalyst, where the catalyst is a carbon-supported, metal-based, lithium-air battery catalyst. In some embodiments, the functionalized carbon support material includes one or more functional groups selected from hydroxyl, carboxyl, carbonyl, quinone, alkyl halide, amide, alkene, or ether functional groups. In some embodiments, the process also includes treating a carbon support material with an oxidizing agent to form an oxidized carbon support material, and treating the oxidized carbon support material with acid to form the functionalized carbon support material.

In some embodiments, the carbon support material includes a high surface area carbon material. In other embodiments, the high surface area carbon material includes microporous carbon, mesoporous carbon, mesoporous microbeads, graphite, expandable graphite, carbon black, or carbon nanotubes. Commercial examples of carbon black include, but are not limited to, Super P, Black Pearl 2000, Denka Black, Vulcan XC72R, Ketjen black. In other embodiments, the oxidizing agent includes a permanganate, a peroxide, a halogen, an acid, a chlorite, a chlorate, a perchlorate, a hypochlorite, a perborate, ozone, nitrous oxide, silver oxide, osmium tetraoxide, Tollen's reagent, or a disulfide. In some such other embodiments, the oxidizing agent includes a permanganate, a peroxide, a halogen, an acid, a chlorite, a chlorate, a perchlorate, a hypochlorite, a perborate, ozone, nitrous oxide, silver oxide, osmium tetraoxide, Tollen's reagent, or a disulfide.

In some embodiments, the metal salt includes a metal nitrate, a metal halide, or a metal sulfate, an alkali metal transition metal oxide or a metal carbonate. In any of the above processes, the catalyst may include a single-, binary- or ternary-metal oxide. In some embodiments, the metal solution includes a metal salt including Fe(NO₃)₃, Fe(NO₃)₂, Fe₂(SO₄)₃, FeSO₄, FeCl₃, FeCl₂, FeBr₃, FeBr₂, MnCl₂, MnBr₂, MnSO₄, Mn(NO₃)₂, CoCl₂, CoBr₂, CoSO₄, Co(NO₃)₂, Ti(NO₃)₄, Ti(NO₃)₃, TiCl₄, TiCl₃, ZrCl₄, ZrCl₃, ZnCl₂, ZnBr₂, PtCl₄, PdCl₄, PtBr₄, PdBr₄, Pt(NO₃)₄, Pd(NO₃)₄, Pt(SO₄)₂, Pd(SO₄)₂, AgCl, AgBr, Ag₂SO₄, AgNO₃, AuCl, AuBr, Au₂SO₄, AuNO₃, Ce(NO₃)₃, Ce₂(CO₃)₃, La(NO₃)₃, La₂(CO₃)₃, or a hydrate of thereof. In some embodiments, the metal hydroxide or metal carbonate includes Pt, Pd, Fe, Ti, Zr, Zn, Ag, Au, Ni, Co, Mn, Ce or La. In some embodiments, the metal-based catalyst includes an oxide of Pt, Pd, Fe, Ti, Zr, Zn, Ag, Au, Ni, Co, Mn, Ce or La. In some embodiments, the transition metal-based catalyst is a metal oxide catalyst that includes Fe₃O₄, Fe₂O₃, CoFe₂O₄, Co₃O₄, TiO₂, NiO₂, ZrO₂, ZnO, MnO₂, CeO₂, or LaO₂, or a perovskite material formula ABO₃, where A is a rare-earth metal ion and B is a transition metal ion.

In some embodiments, the depositing includes precipitating the metal oxide, metal hydroxide, or metal carbonate from the metal solution onto the surface of the functionalized carbon support material. In some embodiments, the depositing includes reacting the metal solution with the functionalized carbon support material, and the first material includes a chemically bonded metal oxide, metal hydroxide, or metal carbonate to the surface of the functionalized carbon support material. The above processes may include treating a carbon support material with an oxidizing agent at neutral or acidic pH to form the functionalized carbon support material. The above processes may include depositing of the metal hydroxide or metal carbonate onto the surface of the functionalized carbon support material at a pH from 2 to 13. In some such embodiment, the pH is from 5 to 10.

In any of the above processes, the sintering temperature is between 25° C. and 600° C. In any of the above processes the sintering may be conducted in an atmosphere including air, oxygen, hydrogen, or an inert gas.

In some embodiments, the first material includes a nano-sized metal oxide, metal hydroxide, or metal carbonate on the surface of the functionalized carbon support material.

In another aspect, a process is provided including precipitating a metal oxide from a metal solution onto the surface of a functionalized carbon support material to form a carbon supported catalyst material including a metal-based catalyst. In some embodiments, the metal-based catalyst is a metal oxide catalyst. In some embodiments, the functionalized carbon support material includes hydroxyl groups, carboxyl groups, or quinone groups. In some embodiments, also includes contacting a carbon support material with an oxidizing agent and followed by the acid treatment to form the functionalized carbon support material.

In some embodiments, the carbon support material includes a high surface area carbon material. In other embodiments, the high surface area carbon material includes microporous carbon, mesoporous carbon, mesoporous microbeads, graphite, expandable graphite, carbon black, or carbon nanotubes. In other embodiments, the oxidizing agent includes a permanganate, a peroxide, a halogen, an acid, a chlorite, a chlorate, a perchlorate, a hypochlorite, a perborate, ozone, nitrous oxide, silver oxide, osmium tetraoxide, Tollen's reagent, or a disulfide. In some such other embodiments, the oxidizing agent includes potassium permanganate, ozone, hydrogen peroxide, nitric acid, sulfuric acid, chlorine gas, sodium hypochlorite, sodium perborate, 2,2′-dipyridyldisulfide.

In some embodiments, the metal salt includes a metal nitrate, a metal halide, or a metal sulfate, or an alkali metal transition metal oxide. In some embodiments, the t metal solution includes a metal salt including Fe(NO₃)₃, Fe(NO₃)₂, Fe₂(SO₄)₃, FeSO₄, FeCl₃, FeCl₂, FeBr₃, FeBr₂, MnCl₂, MnBr₂, MnSO₄, Mn(NO₃)₂, CoCl₂, CoBr₂, CoSO₄, Co(NO₃)₂, Ti(NO₃)₄, Ti(NO₃)₃, TiCl₄, TiCl₃, ZrCl₄, ZrCl₃, ZnCl₂, ZnBr₂, PtCl₄, PdCl₄, PtBr₄, PdBr₄, Pt(NO₃)₄, Pd(NO₃)₄, Pt(SO₄)₂, Pd(SO₄)₂, AgCl, AgBr, Ag₂SO₄, AgNO₃, AuCl, AuBr, Au₂SO₄, AuNO₃, Ce(NO₃)₃, Ce₂(CO₃)₃, La(NO₃)₃, La₂(CO₃)₃, or a hydrate of thereof. In some embodiments, the metal-based catalyst includes Pt, Pd, Fe, Ti, Zr, Zn, Ag, Au, Ni, Co, Mn, Ce, or La.

In some embodiments, the contacting a carbon support material with an oxidizing agent is performed at a neutral to acidic pH. In some embodiments, the precipitating the metal onto the surface of the carbon support material includes lowering the pH of the metal solution.

In another aspect, a carbon supported catalyst material is provided as produced by any of the processes described above.

In another aspect, a cathode includes the carbon supported catalyst material produced by the any of the process above, a binder, and a current collector. In some embodiments, the binder includes poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatine, or a copolymer of any two or more such polymers. In other embodiments, the current collector includes aluminum, nickel, platinum, palladium, gold, silver, copper, iron, stainless steel, rhodium, manganese, vanadium, titanium, tungsten, carbon coated aluminum or carbon paper.

In yet another aspect, an electrochemical device is provided that includes an anode including lithium; a non-aqueous electrolyte; and a cathode; wherein the cathode includes: a binder, a current collector, and a carbon supported catalyst material prepared by a process including: depositing a metal oxide, a metal hydroxide, or a metal carbonate from a metal solution onto the surface of a functionalized carbon support material to form a first material; and sintering the first material to form the catalyst. In one embodiment, the electrolyte includes a solvent and a salt.

### BRIEF DESCRIPTION OF THE DRAWINGS

FIG. 1 is a schematic illustration of a lithium-air cell including a carbon supported catalyst material, according to one embodiment.

FIG. 2 is a TEM image of Fe₃O₄ nanoparticles on a functionalized carbon support material, according to one embodiment.

FIG. 3 is a high-resolution x-ray diffraction (HR-XRD) profile of carbon loaded with Fe₃O₄, according to the examples.

FIG. 4 is a graph of the charging/discharging profile of an Fe₃O₄-based air cathode with the first discharge capacity as high as about 1000 mAh/g, according to one embodiment.

FIG. 5 is a graph of the cycling performance of Li-air cells with Fe₃O₄ and MnO₂ as the catalysts, according to various embodiments.

### DETAILED DESCRIPTION

In one aspect, a process is provided for preparing a cathode for a metal-air battery. The cathode includes a carbon support material having a nano-disperse catalyst. In some embodiments, the nano-disperse catalyst is deposited to the carbon support material. The process may also include an activation step that includes oxidizing the carbon followed by an acid treatment to form functional groups on the surface of carbon. In batteries having such a prepared cathode, the catalyst lowers the activation energy required for the lithium-air reaction.

The process for preparing the cathodes may generally be characterized as a two-step process. In a first step, the carbon support material is treated with an oxidation agent, followed by the acid treatment thereby functionalizing the surface of the carbon support material with functional groups. This is also called the activation step. In a second step, the catalyst is prepared in-situ, depositing on the surface of carbon via the surface functional groups. The catalyst is formed as a nano-size particles dispersed on the surface of functionalized carbon material. However, the steps may independently be conducted. For example, it is not necessary that the first step be conducted at the same time or immediately prior to the second step. It may be sufficient that the functionalized carbon support material is provided, and the second step is performed in isolation of the first step.

In the first step, the carbon support material is treated with an oxidation agent followed by acid treatment. Suitable carbon support materials include, but are not limited to microporous carbon, mesoporous carbon, mesoporous microbeads, graphite, expandable graphite, carbon black, carbon nanotubes and other high surface area carbon substrates. Commercial examples of carbon black include, but are not limited to Super P, Black Pearl 2000, Denka Black, Vulcan XC72R, and Ketjen black. Oxidation agents may include, but are not limited to permanganates, peroxides, halogens, acids, chlorites, chlorates, perchlorates, hypochlorites, perborates, nitrous oxide, silver oxide, ozone, OsO₄, Tollen's reagent, disulfides, and the like. Illustrative oxidation agents may include, potassium permanganate, hydrogen peroxide, nitric acid, sulfuric acid, chlorine gas, sodium hypochlorite, sodium perborate, 2,2′-dipyridyldisulfide, OsO₄, and ozone. Mixtures of any two or more oxidation agents may also be used.

For the first step, the carbon support material is suspended in a solvent. Suitable solvents include, but are not limited to water, methanol, ethanol, and acetone. In one embodiment, the solvent includes water. The concentration of the oxidation agent in the solvent may be from about 0.1 M to about 2 M. In some embodiments, the concentration of the oxidation agent in the solvent is from about 0.5 M to about 2 M.

The carbon support material is treated with the oxidation agent for a time period that is sufficient to oxidize the surface. The time period may be varied and be determined by the specific materials and reagents that are to be used. However, in some cases the time period may range from about one minute to one week, or more. In some embodiments, the time period is from about one minute to about 24 hours. In some embodiments, the time period is from about four hours to about sixteen hours. After contacting the oxidation agent with the carbon support material, excess, or spent oxidation agent may be removed from the carbon support material by washing the carbon support material with sufficient water, methanol, ethanol, or acetone until the washing agent has a pH of from about 6 to 7. The oxidized carbon is then treated with acid to form functional acidic groups such as carboxylic groups, hydroxyl groups, quinone groups, and other oxidized groups. The carbon support material having such functional groups may then optionally be dried at elevated temperature to remove the water or alcohol that was present during the fabrication and washing steps.

In the second step, generally, the catalyst interacts with the functional groups and deposits on carbon surface in a highly dispersed manner with a nano-phase structure. The catalyst is deposited in-situ from a catalyst precursor that is a soluble salt of the metal of the catalyst. The catalyst precursor and the functionalized carbon support material are mixed in water, methanol, ethanol, or acetone, to form a catalyst precursor solution with a suspended carbon support material, and for a time period that is sufficient to intimately mix these materials. In some embodiments, the solvent is water and the catalyst precursor solution is an aqueous catalyst precursor solution. Because the catalyst precursor is soluble, thorough mixing with the carbon support material is enhanced. The time period for mixing of the catalyst precursor and the carbon support material may be individually determined for the specific materials that are to be used. However, the time period for mixing of the catalyst precursor and the carbon support material may range from about one minute to about one day. In some embodiments, the time period for mixing of the catalyst precursor and the carbon support material may be from about 10 minutes to six hours.

After the catalyst precursor and the carbon support material are mixed, the pH of the aqueous solution is then adjusted, accordingly, by addition of a base or a acid. As the base or acid is added, the catalyst is deposited on the functionalized surfaces of the carbon support material. Without being bound by theory, it is believed that the catalyst deposits to the carbon support material through the functional groups, as the catalyst is formed. In some embodiments, after the catalyst precursor and the carbon support material are mixed, the pH of the aqueous solution is raised by addition of a base. As the base is added, the catalyst is deposited on the surfaces of the carbon support material, as a metal hydroxide or metal carbonate, which reacts with the functional groups on the surface of the carbon support material. In other embodiments, after the catalyst precursor and the carbon support material are mixed, the pH of the aqueous solution is lowered by addition of an acid. As the pH of the solution is reduced, the catalyst precursor is converted to a metal oxide and directly deposited on the surface of the functionalized carbon material.

The catalyst precursor and the carbon support material are held in contact with each other for a time period that is sufficient to reach reaction completion or a desired catalyst loading on the carbon support material. This time period may vary and be individually determined for the specific materials that are to be used. However, in some cases the time period may range from about one minute to one week, or more. In some embodiments, the time period is from about one minute to about 24 hours. In some embodiments, the time period is from about four hours to about sixteen hours.

After deposition, the carbon supported metal hydroxide or oxide material that is formed is collected and washed with a washing agent, such as water, until the washes are neutral or slightly acidic. For example, the material may be washed until the pH of the washes are from about 6 to about 7. After washing, the carbon supported-metal hydroxide may be sintered to produce the metal oxide catalyst deposit to the surface of the catalyst support material. Such sintering may include the use of a reducing and/or inert atmosphere. Reducing gases such as H₂, CO, mixtures thereof, or mixtures with inert gases such as He, Ar, Ne, N₂, and the like may be used as the reducing atmosphere. Alternatively, the atmosphere may be an inert gas as listed above. After washing the carbon supported metal oxide may be dried without sintering. Where sintering is performed, it is at a temperature from about 25° C. to about 800° C. In some embodiments, the sintering is performed from about 400° C. to about 600° C.

Suitable catalyst precursor materials include those of a metal salt that are water soluble. For example, the catalyst precursor may be a metal nitrate salt, halide salt, sulfate salt, oxide salt or carbonate salt. Illustrative catalyst precursors may include, but are not limited to, Fe(NO₃)₃, Fe(NO₃)₂, Fe₂(SO₄)₃, FeSO₄, FeCl₃, FeCl₂, FeBr₃, FeBr₂, MnCl₂, MnBr₂, MnSO₄, Mn(NO₃)₂, KMnO₄, CoCl₂, CoBr₂, CoSO₄, Co(NO₃)₂, Ti(NO₃)₄, Ti(NO₃)₃, TiCl₄, TiCl₃, ZrCl₄, ZrCl₃, ZnCl₂, ZnBr₂, PtCl₄, PdCl₄, PtBr₄, PdBr₄, Pt(NO₃)₄, Pd(NO₃)₄, Pt(SO₄)₂, Pd(SO₄)₂, AgCl, AgBr, Ag₂SO₄, AgNO₃, AuCl, AuBr, Au₂SO₄, and AuNO₃, Ce(NO₃)₃, Ce₂(CO₃)₃, La(NO₃)₃, La₂(CO₃)₃ or a hydrate of any such materials. The catalyst precursor may be a mixture of any two or more catalyst precursors.

Suitable catalyst precursor materials include those of a metal salt that are water soluble. For example, the catalyst precursor may be a metal nitrate salt, halide salt, sulfate salt, or oxide salt. Illustrative catalyst precursors may include, but are not limited to, Fe(NO₃)₃, Fe(NO₃)₂, Fe₂(SO₄)₃, FeSO₄, FeCl₃, FeCl₂, FeBr₃, FeBr₂, MnCl₂, MnBr₂, MnSO₄, Mn(NO₃)₂, KMnO₄, CoCl₂, CoBr₂, CoSO₄, Co(NO₃)₂, Ti(NO₃)₄, Ti(NO₃)₃, TiCl₄, TiCl₃, ZrCl₄, ZrCl₃, ZnCl₂, ZnBr₂, PtCl₄, PdCl₄, PtBr₄, PdBr₄, Pt(NO₃)₄, Pd(NO₃)₄, Pt(SO₄)₂, Pd(SO₄)₂, AgCl, AgBr, Ag₂SO₄, AgNO₃, AuCl, AuBr, Au₂SO₄, AuNO₃, Ce(NO₃)₃, Ce₂(CO₃)₃, La(NO₃)₃, La₂(CO₃)₃ or a hydrate of any such materials. The catalyst precursor may be a mixture of any two or more catalyst precursors.

Suitable catalyst materials include, but are not limited to, metals and metal oxides and mixtures of any two or more such materials. For example, the catalyst may include metals such as, but not limited to Pt, Pd, Fe, Ti, Zr, Zn, Ag, Au, Ni, Co, Mn, Ce, and La, or oxides of any such metals. In some embodiment, the catalyst is a metal, such as Pt, Pd, Au, Ag or Fe, which provide for catalytic function for the oxygen reduction reaction (ORR) and oxygen evolution reaction (OER). Illustrative transition metal oxides include, but are not limited to, PdO, Fe₃O₄, Fe₂O₃, CoFe₂O₄, Co₃O₄, TiO₂, NiO₂, ZrO₂, ZnO, MnO, Mn₂O₃, MnO₂, CeO₂ and LaO₂.

The overall process described above may be summarized as follows. A metal hydroxide or metal carbonate or metal oxide is precipitated from a metal salt solution onto the surface of a carbon support material having functional groups. If it is a metal hydroxide or metal carbonate, the metal hydroxide and carbon support material is then sintered at reducing or inert gas environment to form a carbon supported catalyst material that includes a metal oxide catalyst. If it is a metal oxide precipitated on the surface of functionalized carbon, the product only need to be dried to remove the washing agent.

After preparation of the carbon supported catalyst material, it is then formed into a cathode for a lithium-air battery. The cathode is prepared by mixing the carbon supported catalyst materials with a binder and applying the material to a current collector. For example, the carbon supported catalyst material may be mixed in a solvent with the binder to form a slurry that is then applied to the current collector. Illustrative binders include, but are not limited to, poly(acrylonitrile)PAN, poly(vinylidene fluoride) (PVDF), polyvinyl alcohol (PVA), polyethylene, polystyrene, polyethylene oxide, polytetrafluoroethylene (Teflon), polyimide, styrene butadiene rubber (SBR), carboxy methyl cellulose (CMC), gelatine, a copolymer of any two or more such polymers, or a blend of any two or more such polymers. In some embodiments, the binder includes PVDF. In other embodiments, the binder includes polyimide.

In comparison to conventionally produced metal oxide-carbon support materials, i.e. prepared by powder mixing of the individual components, cathodes made with the carbon support catalyst materials described above exhibit approximately three times the capacity. Therefore, loadings of such carbon supported catalysts in the cathode may be greatly reduced in comparison. For example, loading of the catalyst on the carbon support material may be from about 2 wt % to about 20%. In some embodiments, the loading of the catalyst on the carbon support material may be from about 2 wt % to about 15%. In other embodiments, the loading of the catalyst on the carbon support material may be from about 2 wt % to about 10%. In comparison to conventionally produced metal oxide-carbon support materials, the loading is approximately 20 wt % to 50 wt %.

The current collector provides contact between the electroactive material and an external load to allow for the flow of electrons through a circuit to which the electrode is connected. The current collector may be a conductive material. Illustrative current collectors include, but are not limited to, carbon paper, aluminum, nickel, platinum, palladium, gold, silver, copper, iron, stainless steel, rhodium, manganese, vanadium, titanium, tungsten, or aluminum carbon coated or any carbon-coated metal. In some embodiments, the current collector is carbon paper, aluminum or copper. For an air cathode, having substantial surface area contact with the air enhances the efficiency of the electrode. Accordingly, in some embodiments, the current collector has a substantial surface area. This may be accomplished by providing the current collector as a screen or other mesh structure such that surface area of the material is increased over a wire or paddle-like formation. Thus, in one embodiment, the current collector includes any of the above materials as a mesh. In one such embodiment, the current collector is a carbon paper or an aluminum mesh.

Accordingly, in some embodiments, a cathode is provided that includes any of the carbon supported catalyst material produced above, a binder, and a current collector. In some embodiments, the binder includes poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatine, a copolymer of any two or more such polymers, or a blend of any two or more such polymers. In other embodiments, the current collector includes aluminum, nickel, platinum, palladium, gold, silver, copper, iron, stainless steel, rhodium, manganese, vanadium, titanium, tungsten, or carbon coated aluminum. In other embodiments, the current collector includes carbon paper, aluminum or copper. In yet other embodiments, the current collector is a carbon paper and mesh material. In further embodiments, the current collector includes a carbon paper or an aluminum mesh.

In another aspect, a lithium-air battery is provided that includes the cathode as prepared by any of the above processes. During operation of such a lithium-air battery, the cathode provides for the decomposition of oxygen, in the presence of lithium, to Li₂O or Li₂O₂, at the catalyst surface. In a reversible air-cathode cell, oxide anions, O²⁻, or peroxide anions, O₂²⁻, are re-converted to oxygen. The catalyst on the surface of the carbon support material is also important for the reverse reactions.

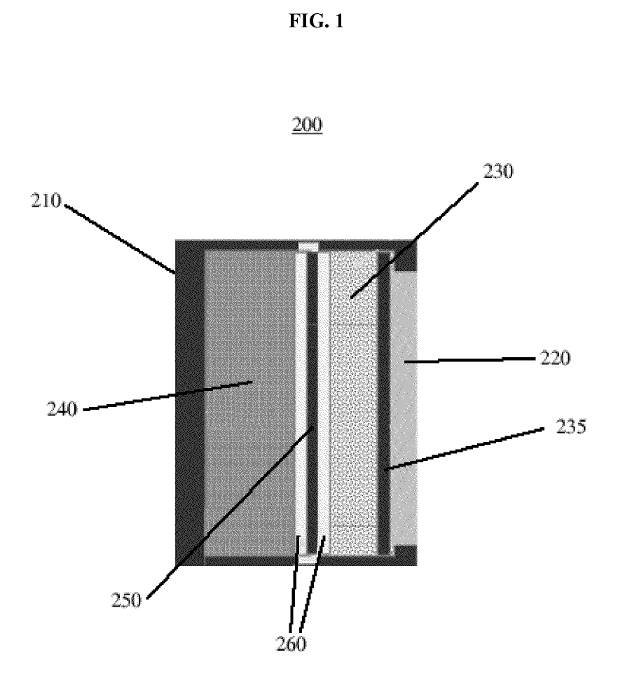

In addition to the cathode, lithium air batteries also include an anode and a non-aqueous electrolyte. In some embodiments, a lithium air battery also includes a porous separator. FIG. 1 is a schematic illustration of a lithium-air cell. The cell 200 is contained by a holder 210 having an aperture 220 through which the cell 200 is exposed to air. The cathode 230, which is prepared by coating active material either on an aluminum mesh or on a carbon paper, is located in close proximity to the aperture 220, thereby maximizing contact with the oxygen for cell operation. The mesh 235 is between cathode 230 and aperture 220, serving as an extra current collector. The cathode 230 is separated from the lithium anode 240 by a porous separator 250. The cell 200 also contains an electrolyte 260 in contact with both the cathode 230 and the anode 240, to facilitate charge transfer.

The anode for such batteries includes lithium. Suitable non-aqueous electrolytes include a solvent and a salt. Suitable solvents for the non-aqueous electrolyte include, but are not limited to, carbonate-based solvents, oligo(ethyleneglycol)-based solvents, fluorinated oligomers, dimethoxyethane, triglyme, dimethylvinylene carbonate, tetraethyleneglycol, dimethyl ether, polyethylene glycols, sulfones, sulfolane, and γ-butyrolactone. Of course, the solvent may be a mixture of such solvents. The solvents support lithium-ion and oxygen transport through electrochemical cells prepared with the solvents. Porous separators include, but are not limited to, polymer separators, ceramic separators, glass fiber separators, and the like. For example, illustrative porous separators include, but are not limited to, glass fibers, Celgard polymer separator, polyimide, solid lithium polymer electrolyte such as LiPON (lithium phosphorus oxynitride).

In some embodiments, the salt is a lithium salt. Illustrative lithium salts are not particularly limited, as long as it dissolves in the solvent of the electrolyte. Illustrative lithium salts that may be used in the electrolytes include, but are not limited to, LiClO₄, LiBF₄, LiAsF₆, LiSbF₆, LiPF₆, LiCF₃SO₃, Li(CF₃SO₂)₂N, Li(CF₃SO₂)₃C, LiC₆F₅SO₃, LiAlCl₄, LiGaCl₄, LiSCN, LiO₂, LiCO₂CF₃, LiN(SO₂C₂F₅)₂, lithium alkyl fluorophosphates, lithium tris(oxalate) phosphate Li[P(C₂O₄)₃] and Li[PF₂(C₂O₄)₂]₅ Li[PF₄(C₂O₄)], lithium bis(oxalato) borates Li[B(C₂O₄)₂] and Li[BF₂C₂O₄], Li₂B₁₂X₁₂₋ₙHₙ, wherein X is OH, F, Cl, or Br, and n ranges from 0 to 12, or Li₂B₁₀X₁₀₋ₙHₙ, wherein X is OH, F, Cl, or Br, and n ranges from 0 to 10.

Accordingly, in one embodiment, an electrochemical device is provided that includes an anode including lithium; a non-aqueous electrolyte; and a cathode that includes any of the carbon supported catalyst materials described above. In some embodiments, the electrolyte includes a solvent and a salt.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The present technology, thus generally described, will be understood more readily by reference to the following examples, which are provided by way of illustration and are not intended to be limiting.

### EXAMPLES

### Example 1

Preparation of a functionalized carbon support material. 10 gram of carbon black (one such commercially available material is Super P, or Super P Li, available from TIMCAL Graphite and Carbon, Westlake, Ohio) was added to a 200 ml 1.0M KMnO₄ (about 0.5 M to about 2 M) solution and stirred for overnight. The material was then collected and washed with water, until the pH value of the washing water was from about 5 to about 7. The material was then added to a 100 ml of 4 M HCl solution, and stirred overnight at room temperature. Again, the material was collected by filtration and washed. The material was then dried overnight in an oven at 110° C. to provide the functionalized carbon support material.

### Example 2

Preparation of a nano-dispersed Fe₃O₄ on the functionalized carbon support material. The carbon support material of Example 1 is thoroughly mixed with water. An Fe(NO₃)₃ solution (1M, 12.5 ml), was then added to the carbon support material suspended in the water. The mixture was then stirred for 4 hrs. A solution of Na₂CO₃ or NH₄OH in water (1M, 50 ml), was then added dropwise to the Fe(NO₃)₃-carbon mixture with vigorous stirring, until the pH of the mixed solution was from about 8 to about 12. The resultant mixture was then stirred overnight to form the carbon supported catalyst material. After the reaction, the resultant material was collected and washed with water, until the pH of the washes was from about 6 to about 7. The material was then subject to sintering at a temperature of from 400-450° C. in the environment of Ar with 3.5% H₂ (reducing atmosphere) to produce the carbon supported catalyst material.

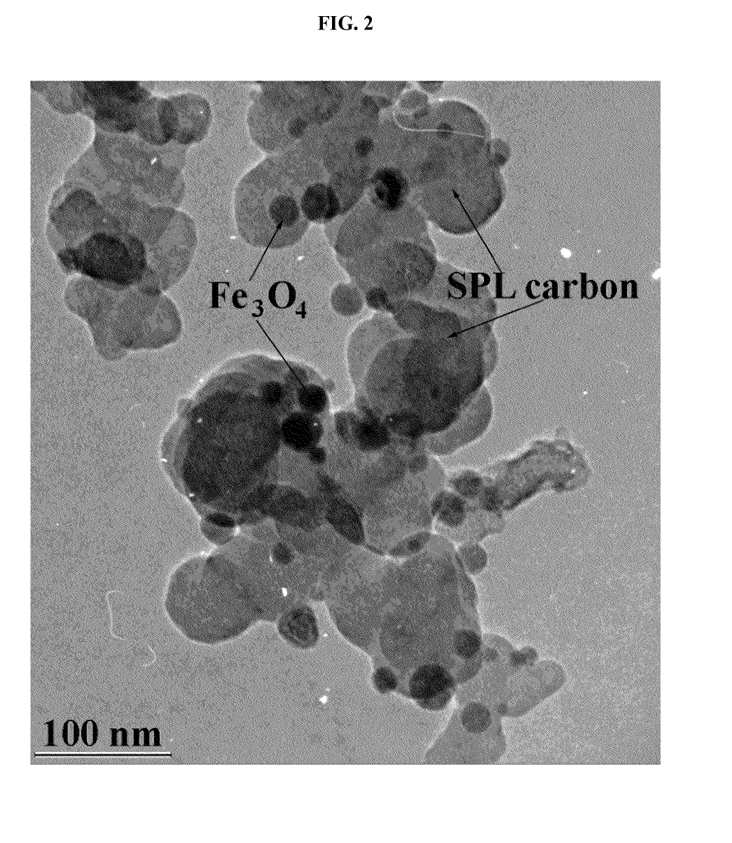

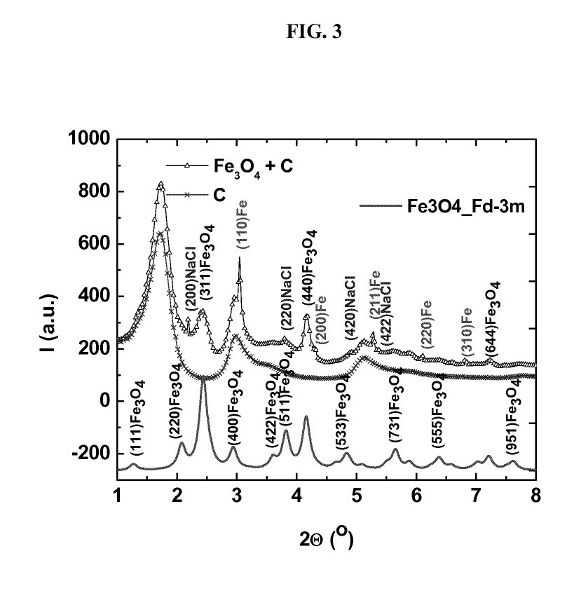

In Example 2, Fe₃O₄, is prepared in-situ for loading onto the surface of the carbon supporting material through the functional groups. Scanning electron microscope (SEM) images of the carbon supporting material loaded with catalyst, show the Fe₃O₄, as white dots of about 30 nm in size. Electron dispersive x-ray (EDX) elemental analysis confirms the existence of the iron on the carbon, and transmission electron microscope (TEM) images (FIG. 2) show the Fe₃O₄ catalyst particles as tiny dots from about 10 nm to about 30 nm in size. The TEM image also shows a uniform distribution of the catalyst within the carbon supporting substrate. FIG. 3 is an x-ray diffraction (XRD) spectrum identifying the Fe₃O₄. The thick black curve with identified phase index on each peak belongs to the prepared catalytic air cathode material, while the thick red curve belongs to the pure carbon supporting material, which serves as a base line. The thin black, red and blue curves underneath belong to pure Fe₃O₄, Fe, and NaCl, respectively. This further confirms the catalyst is Fe₃O₄.

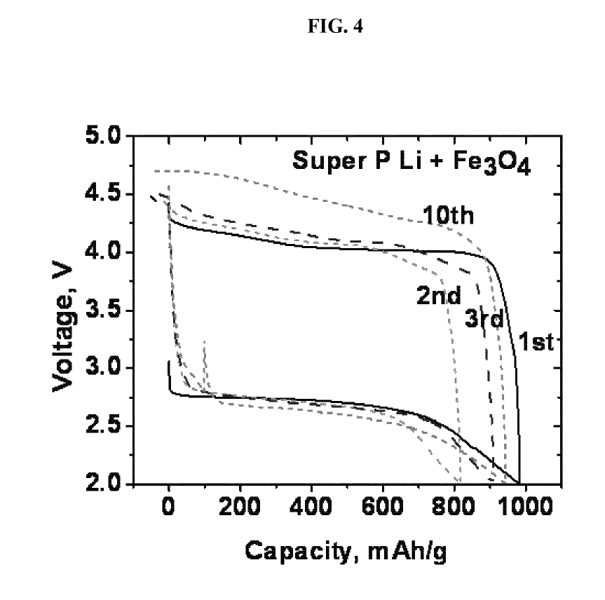

Charge/discharge voltage profiles of an carbon supported Fe₃O₄-based air cathode are illustrated in FIG. 4. The first discharge capacity is about 1,000 mAh/g. The initial discharge reaction takes place at approximately 2.75 V vs. Li⁺/Li (discharge rate is 0.05 mA/cm²), and charge voltage at around 4 V vs. Li+/Li. The first round efficiency is about 69%, among the highest in the literature. Even after 10 cycles, the efficiency can still be maintained around 60%.

### Example 3

Preparation of a nano-disperse MnO₂ on a carbon support material. MnSO₄.H₂O (2.125 g) and KMnO₄ (0.858 g) were ground together at a mole ratio of 2.3 to form a mixed powder. The mixed powder was then transferred to a beaker containing 100 ml water. Then oxidized carbon support material (1.56 g or 14 g) from Example 1 was then added. After stirring for 2 hour, a 1 M H₂SO₄ (50 mL) solution was added, and the stirring continued overnight at room temperature. The reaction product was washed with water and filtrated and dried in oven at 110° C., overnight. In contrast to Example 2, where the metal is iron and the deposition is via an iron hydroxide species, no sintering is required for the Mn example, as the manganese oxide is deposited directly from solution.

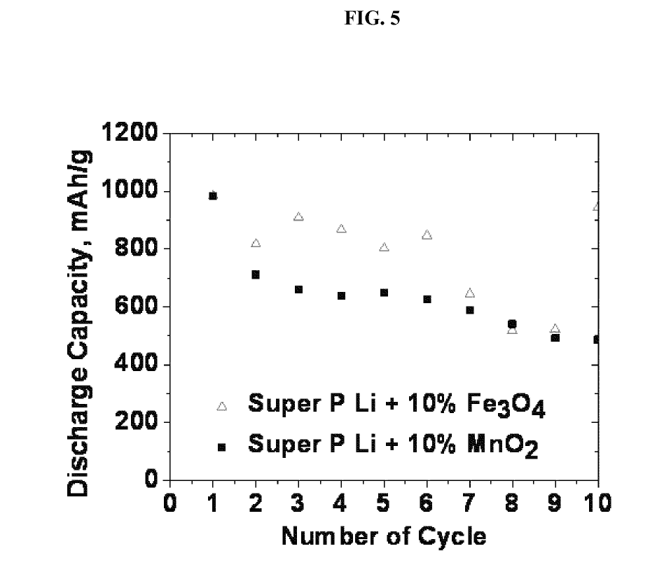

FIG. 5 is graph of the cycling performance of Li-air cells with Fe₃O₄ catalyst (Example 2) and MnO₂ catalyst (Example 3). The first discharge capacity of the air cathodes containing Fe₃O₄ or MnO₂ as the catalyst is close to 1000 mAh/g (carbon and catalyst). When Fe₃O₄ is used as the catalyst, the capacity can be maintained above 800 mAh/g for the first 6 cycles. The capacity can be maintained above 600 mAh/g for the first 6 cycles when MnO₂ is used as the catalyst. Both electrodes demonstrate a good cycling performance for at least ten cycles.

### Example 4

Preparation of a laminate cathode. The nano-disperse Fe₃O₄ on the carbon support material was ground to a fine powder and mixed with PVdF and acetone to form a slurry. After stirring the slurry for 3 hrs, it was cast onto an aluminum mesh or carbon paper current collector and dried overnight.

### Example 5

Preparation of a lithium-air battery. The electrochemical characterizations of the lithium-air battery were carried out using a Swagelok-type cell, which is composed of a lithium metal anode, electrolyte (1M LiPF₆ in propylene carbonate (PC) impregnated into a glass fiber separator) and a porous cathode (11 mm in diameter). The cathode was prepared following the description in Example 4. The cells were sealed except for the Al grid or carbon paper window that exposed the porous cathode to 1 bar O₂ pressure. The electrochemical measurements were carried out using a MACCOR cycler. The discharge-charge performance was conducted in the voltage range of 2.0-4.4 V at a constant current of 0.05 mA/cm⁻², and the cell was maintained in 1 bar O₂ atmosphere to avoid any negative effects of humidity and CO₂.

The embodiments, illustratively described herein, may suitably be practiced in the absence of any element or elements, limitation or limitations, not specifically disclosed herein. Thus, for example, the terms “comprising,” “including,” “containing,” etc., shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A process for preparing a catalyst, the process comprising:
depositing a metal oxide, a metal hydroxide, or a metal carbonate from a metal solution onto the surface of a functionalized carbon support material to form a first material; and
sintering the first material to form the catalyst;
wherein:
the catalyst is a carbon-supported, metal-based, lithium-air battery catalyst.

2. The process of claim 1, wherein the functionalized carbon support material comprises one or more functional groups selected from the group consisting of hydroxyl, carboxyl, carbonyl, quinone, alkyl halide, amide, alkene, and ether functional groups.

3. The process of claim 1 further comprising treating a carbon support material with an oxidizing agent to form an oxidized carbon support material, and treating the oxidized carbon support material with acid to form the functionalized carbon support material.

4. The process of claim 3, wherein the carbon support material comprises a high surface area carbon material.

5. The process of claim 3, wherein the oxidizing agent comprises a permanganate, a peroxide, a halogen, an acid, a chlorite, a chlorate, a perchlorate, a hypochlorite, a perborate, ozone, nitrous oxide, silver oxide, osmium tetraoxide, Tollen's reagent, or a disulfide.

6. The process of claim 3, wherein the oxidizing agent comprises potassium permanganate, ozone, hydrogen peroxide, chlorine gas, sodium hypochlorite, sodium perborate, nitric acid, sulfuric acid, hydrochloric acid, or 2,2′-dipyridyldisulfide.

7. The process of claim 1, wherein the metal solution comprises a metal salt comprising a metal nitrate, a metal halide, a metal carbonate, or a metal sulfate, or an alkali metal transition metal oxide.

8. The process of claim 1, wherein the metal solution comprises a metal salt comprising Fe(NO₃)₃, Fe(NO₃)₂, Fe₂(SO₄)₃, FeSO₄, FeCl₃, FeCl₂, FeBr₃, FeBr₂, MnCl₂, MnBr₂, MnSO₄, Mn(NO₃)₂, CoCl₂, CoBr₂, CoSO₄, Co(NO₃)₂, Ti(NO₃)₄, Ti(NO₃)₃, TiCl₄, TiCl₃, ZrCl₄, ZrCl₃, ZnCl₂, ZnBr₂, PtCl₄, PdCl₄, PtBr₄, PdBr₄, Pt(NO₃)₄, Pd(NO₃)₄, Pt(SO₄)₂, Pd(SO₄)₂, AgCl, AgBr, Ag₂SO₄, AgNO₃, AuCl, AuBr, Au₂SO₄, AuNO₃, Ce(NO₃)₃, Ce₂(CO₃)₃, La(NO₃)₃, La₂(CO₃)₃ or a hydrate of thereof.

9. The process of claim 1, wherein the depositing comprises precipitating the metal oxide, metal hydroxide, or metal carbonate from the metal solution onto the surface of the functionalized carbon support material.

10. The process of claim 1, wherein the depositing comprises reacting the metal solution with the functionalized carbon support material, and the first material comprises a chemically bonded metal oxide, metal hydroxide, or metal carbonate to the surface of the functionalized carbon support material.

11. The process of claim 1, wherein the sintering temperature is between 25° C. and 600° C.

12. The process of claim 1, wherein the first material comprises a nano-sized metal oxide, metal hydroxide, or metal carbonate on the surface of the functionalized carbon support material.

13. The process of claim 1, wherein the catalyst comprises Pt, Pd, Fe, Ti, Zr, Zn, Ag, Au, Ni, Co, Mn, Ce or La.

14. The process of claim 1, wherein the catalyst comprises single-, binary- and ternary-metal oxide.

15. The process of claim 1, wherein the catalyst comprises Fe₃O₄, Fe₂O₃, CoFe₂O₄, Co₃O₄, TiO₂, CuO, Cu₂O, NiO₂, ZrO₂, ZnO, MnO₂, CeO₂, LaO₂, LaCeO2, or a perovskite material formula ABO₃, wherein A is a rare-earth metal ion and B is a transition metal ion.

16. The process of claim 1 further comprising treating a carbon support material with an oxidizing agent at neutral or acidic pH to form the functionalized carbon support material.

17. The process of claim 1, wherein the depositing of the metal hydroxide or metal carbonate onto the surface of the functionalized carbon support material is conducted at a pH from 2 to 13.

18. The process of claim 1, wherein the depositing of the metal hydroxide or metal carbonate onto the surface of the functionalized carbon support material is conducted at a pH from 5 to 10.

19. A cathode comprising the carbon supported catalyst produced by the process of claim 1, a binder, and a current collector.

20. An lithium-air battery comprising:
an anode comprising lithium;
a non-aqueous electrolyte; and
a cathode comprising;
a binder,
a current collector, and
a carbon supported catalyst prepared by a process comprising:
depositing a metal oxide, a metal hydroxide, or a metal carbonate from a metal solution onto the surface of a functionalized carbon support material to form a first material; and
sintering the first material to form the catalyst.
